(19) United States
(12) Patent Application Publication
(10) Pub. No.: US 2020/0315752 A1
(43) Pub. Date: Oct. 8, 2020

(54) Squeeze-out Device for Dental Materials

(71) Applicant: Kulzer GmbH, Hanau (DE)

(72) Inventors: Andreas Grundler, Butzbach (DE); Stephan Schmid, Glauburg (DE); Yvonne Abel, Giessen (DE)

(21) Appl. No.: 16/830,359

(22) Filed: Mar. 26, 2020

(30) Foreign Application Priority Data
Apr. 2, 2019 (DE) 10 2019 108 533.0

(51) Int. Cl. A61C 9/00

(52) U.S. Cl. CPC A61C 9/0026

(57) ABSTRACT

The invention relates to a squeeze-out device for driving out a highly viscous dental material from a cartridge system, having an actuator, a motor, a controller, an operating device and at least one force sensor, wherein at least one discharging plunger of the cartridge system is drivable by the actuator, wherein the actuator is drivable by the motor or mechanically transmitted driving of the actuator is supportable by the motor, wherein the operating device is manually operable, wherein the at least one force sensor is connected to the operating device such that at least the magnitude of a force acting on the operating device and/or at least the magnitude of a torque acting on the operating device is measurable, and wherein the motor is controllable by the controller depending on the measured magnitude of the force acting on the operating device and/or of the torque acting on the operating device, said magnitude being measured by the at least one force sensor. The invention also relates to a method for driving at least one discharging plunger of a cartridge system by means of a squeeze-out device.

The invention relates to a squeeze-out device for highly viscous dental materials, in particular impression compounds, and to a method for driving at least one discharging plunger of a cartridge system for such a dental material.

Modern dental impression compounds are mainly provided in cartridge systems, in particular in two-component cartridges, which are mechanically or electrically extracted by means of a squeeze-out device and mixed. Such a squeeze-out device is known for example from WO 2017/207188 A1. A single-chamber cartridge for self-hardening or moisture-hardening materials, as are used for example for sealing in construction, is known from U.S. Pat. No. 5,909,830 A. For such purposes, pneumatically or electrically driven squeeze-out devices are also commercially available on the market. However, these are not readily suitable for squeezing out dental impression compounds.

Electrical extraction devices mainly mix and meter material from larger cartridges having for example a total content of 350 ml to 400 ml and are used in a stationary manner. These are used to fill dental impression trays. The mixer can in this case likewise be electrically driven. Such systems are known for example from US 2009/279382 A1, US 2015/157429 A1 and DE 20 2006 006 147 U1.

For directly applying dental impression compounds in the patient's mouth, smaller two-component cartridges having two chambers and a content of 5 ml to 100 ml have become established. A squeeze-out device for systems having such small volumes is known for example from US 2018/0250103 A1. However, there are also smaller, serially arranged cartridges having volumes of less than 5 ml. The dental impression compound is placed into a squeeze-out device, also referred to as a “dispensing gun”, and mechanically conveyed by means of a toothed rod acting on discharging plungers in the cartridge. The mixer is statically designed in this case.

These cartridges are used for thin-flowing to highly viscous materials (types 1 to 3 according to DIN ISO 4823:2015, publication date 2015-08). Wherein the impression compounds of higher viscosities (type 1) strain the users due to high squeeze-out forces and thus impede the meterability in the mouth. Excessively large forces can lead to user fatigue and to trembling of the hand and the arm. In addition, pastes of higher viscosities require thicker mixers, which lead to increased material loss as a result of a greater dead volume.

Type 0 materials cannot be applied with the regular static systems as a result of the high necessary squeeze-out forces.

Electrical squeeze-out devices for smaller cartridges having a content of a few milliliters (<<10 ml) are new on the market. The drawback of such squeeze-out devices is that they provide exclusively electrical conveyance and do not give the user any haptic feedback on the conveyed amount and pressure. As a result, the user has no sensation of how much resistance is acting counter to the propulsion of the actuator or counter to the squeeze-out process.

The object of the invention is therefore that of overcoming the drawbacks of the prior art. In particular, it is intended to find a possibility of improving the use and the usability of highly viscous and tough dental materials, in particular dental impression compounds. It is further intended to provide a squeeze-out device with which tough and highly viscous dental impression compounds can also be discharged, it being intended for the user to receive information about the ejection process as in the case of dental impression compounds having low viscosities. The squeeze-out device is intended to be simple as possible to operate and, if possible, not to require habituation during operation. In addition, it is intended for the squeeze-out device to also be operable like conventional squeeze-out devices such that the user does not have to rehabituate during use of the squeeze-out device in order to produce a dental impression compound or another dental material. The assembly is intended to be cost-effective. Furthermore, it is intended for the squeeze-out device to be usable with conventional cartridges. Moreover, different cartridges and cartridge systems are also intended to be operable with the squeeze-out device as far as possible. The user is intended to be able to use the squeeze-out device without a large exertion of force. The squeeze-out device is intended to be reusable such that a new squeeze-out device does not have to be used for each new squeeze-out process.

The problems addressed by the invention are solved by a squeeze-out device for driving out a highly viscous dental material, in particular a highly viscous dental impression compound, from a cartridge system, the squeeze-out device having an actuator, a motor, a controller, an operating device and at least one force sensor, wherein at least one discharging plunger of the cartridge system is drivable by the actuator, wherein the actuator is drivable by the motor or mechanically transmitted driving of the actuator is supportable by the motor, wherein the operating device is manually operable, wherein the at least one force sensor is connected to the operating device such that at least the magnitude of a force acting on the operating device and/or at least the magnitude of a torque acting on the operating device is measurable, and wherein the motor is controllable by the controller depending on the measured magnitude of the force acting on the operating device and/or of the torque acting on the operating device, said magnitude being measured by the at least one force sensor.

According to the invention, an actuator is understood to mean a part of the squeeze-out device with which linear propulsion of the at least one discharging plunger of the cartridge system can be brought about. The actuator can preferably be a linearly propellable ram or a linearly propellable rod. However, other actuators are also conceivable, such as a link chain.

The motor can be directly or indirectly connected to the actuator. The controller can be connected to the motor to control the motor. Furthermore, the controller can be connected to the force sensor. Moreover, the controller can access the data or measured quantities recorded by the force sensor and analyze said data or measured quantities, if desired. The controller can be designed to process the data or the measured quantities from the force sensor.

In addition to dental impression compounds, other dental cements, adhesives or fillings that can be squeezed out by the squeeze-out device according to the invention are also possibilities as dental materials. These are typically squeezed out and optionally applied at lower volumes.

Only the operating device itself, and not the entire squeeze-out device, is intended to be manually operable, since the actuator is intended to be drivable in a motor-driven or at least motor-supported manner. The operating device can therefore be manually operated.

In squeeze-out devices according to the invention, it can be provided that the squeeze-out device is a cartridge gun.

As a result, it is ensured that the squeeze-out device can be used like conventional and known squeeze-out devices. Thus, the user does not have to rehabituate if said user wishes to use a squeeze-out device according to the invention.

Furthermore, it can be provided that the operating device is a trigger, a lever or a button, the squeeze-out device preferably being operable by means of the trigger, the lever or the button using the same hand with which the squeeze-out device is holdable single-handedly.

As a result, the force and/or the torque acting on the trigger or the button as an operating device can be very precisely manually adjusted and measured. Moreover, the squeeze-out device can thus be operated and used single-handedly.

It can also be provided that the squeeze-out device has an energy store, the energy for driving the motor being extractable from the energy store, the energy store preferably being a battery store, a rechargeable battery or a compressed-gas reservoir.

As a result, the squeeze-out device is self-contained and does not have to be connected to an external energy supply. The energy store can have a small capacity because an individual squeeze-out process does not use very much energy. Optionally, the energy store can always be recharged between uses.

Furthermore, it can be provided that the at least one force sensor is suitable or provided for measuring the magnitude of at least one linear force and/or of at least one torque.

As a result, the force sensor is optimized for the intended use. This is because, for this use, it is sufficient to measure only the magnitude of the force and/or the torque in order to thereby control the power of the motor and thus the force exerted on the actuator by the motor. The squeeze-out device can therefore be designed more simply and more cost-effectively than if the direction of the force or the torque were also determined.

According to a further development of the present invention, it can be provided that the controller controls the motor such that the force acting on the actuator from the motor or the torque acting on the actuator from the motor is, in a force range or torque range, proportional to the magnitude of the force acting on the operating device or of the torque acting on the operating device, said magnitude having been measured by the force sensor.

The force acting on the actuator from the motor or the torque acting on the actuator from the motor being, in a range, proportional to the magnitude of the force acting on the operating device, said magnitude having been measured by the force sensor, means that there is at least one force range and/or torque range in which there is proportionality. It can be provided here that a minimum force or a minimum torque is required, and a maximum force or a maximum torque can also be provided, above which the motor is then preferably operated at maximum force or maximum torque.

As a result of the proportionality, it is ensured that by pressing the operating device to different degrees of intensity, the user can be given an impression of the force with which the motor-assisted or motor-supported squeezing out of the dental material or the dental impression compound is taking place.

In squeeze-out devices of this kind, it can be provided that the proportionality is adjustable, preferably manually adjustable by an operating element.

As a result, the squeeze-out device can be adjusted for dental materials or impression compounds having different degrees of toughness but also for users with different levels of strength. As a result, the whole spectrum of user-feasible varyingly forceful operations of the operating device can be utilized to give the user as precise as possible a haptic sensation for the squeeze-out process.

It can also be provided that in addition to the magnitude of the force acting on the operating device and/or of the torque acting on the operating device, the direction of the force and/or the torque is also measurable by the force sensor, the direction of the force and/or the torque preferably being usable to control the motor by means of the controller.

As a result, either additional functions of the squeeze-out device can be provided or the squeeze-out process can be controlled even more precisely in that further intensification of the motor power and thus the squeeze-out process can be achieved by the direction of the force acting on the operating device. The additional information can in particular be used for a finer gradation of the force provided by the motor during the squeeze-out process.

It can further be provided that at least one plate is attached to a front side of the actuator, the at least one discharging plunger of the cartridge system being operable by said plate.

As a result, the at least one discharging plunger can be driven flush with the at least one plate. Uniform propulsion of the at least one discharging plunger of the cartridge system can thus be achieved.

According to a preferred further development, it can be provided that the dependency of a power or force of the motor acting on the actuator on the magnitude of the force acting on the operating device and/or of the torque acting on the operating device, said magnitude having been measured by the force sensor, is adjustable.

As a result, the squeeze-out device can be adjusted for dental materials or impression compounds having different degrees of toughness but also for users with different levels of strength. As a result, the whole spectrum of user-feasible varyingly forceful operations of the operating device can be utilized to give the user a haptic sensation for the squeeze-out process which is as precise as possible.

Preferably it can further be provided that the operating device is connected to the actuator such that a force acting on the operating device and/or a torque acting on the operating device is transmittable to the actuator for driving the at least one discharging plunger of the cartridge system, the force and/or the torque preferably being mechanically transmittable, particularly preferably transmittable by a lever and/or a gearing.

As a result, some of the force applied by the user of the squeeze-out device can be used to propel the actuator. As a result, firstly, energy is saved, and secondly, the squeeze-out device is theoretically also still usable without energy supply. Low-viscosity dental materials or impression compounds can thus also be conveyed without motor support by means of the same squeeze-out device. In addition, a sensation of the force required to propel the actuator arises immediately for the user.

Furthermore, it can be provided that the squeeze-out device is suitable for squeezing out cartridge systems for dental impression compounds, in particular two-component cartridges, and for this purpose has an attachment element, which is attachable to the cartridge system, the cartridge system preferably providing a volume of between 5 ml and 100 ml of the dental impression compound, particularly preferably a volume of between 25 ml and 100 ml, very particularly preferably a volume of 50 ml.

As a result, the squeeze-out device is matched to the size of cartridge systems typical for dental impression compounds.

It can also be provided that the squeeze-out device is suitable for squeezing out cartridge systems for dental impression compounds of type 1 or type 0 according to DIN ISO 4823:2015.

As a result, the squeeze-out device is also suitable for particularly tough impression compounds and offers the user haptic feedback during use, even in the case of a very high viscosity of the dental impression compound.

The problems addressed by the present invention are also solved by a method for driving at least one discharging plunger of a cartridge system by means of a squeeze-out device, characterized by the steps of

A) operating an operating device by means of a force acting on the operating device,

B) measuring, by means of at least one force sensor, the magnitude of a force acting on the operating device and/or of a torque acting on the operating device,

C) driving an actuator by means of a motor, wherein the actuator is provided for propelling at least one discharging plunger of a cartridge system, and wherein the motor is controlled depending on the magnitude of the measured force and/or of the measured torque.

It can be provided here that the method is carried out by a squeeze-out device according to the invention.

The method thus has the advantages mentioned in relation to the squeeze-out devices according to the invention.

It can further be provided that the actuator is additionally driven mechanically by the operating device.

As a result, some of the force applied by the user of the squeeze-out device can be used to propel the actuator. As a result, firstly, energy is saved, and secondly, the method and the squeeze-out device are theoretically also usable without energy supply. In addition, a sensation of the force required for the squeeze-out process arises immediately for the user.

Furthermore, it can be provided that the force acting on the actuator from the motor or the torque acting on the actuator from the motor is, in a range, adjusted proportionally to the magnitude of the force acting on the operating device, said magnitude being measured by the force sensor, a proportionality constant preferably being adjusted.

As a result, the method can be used for dental materials or impression compounds having different degrees of toughness but also for users with different levels of strength. As a result, the whole spectrum of user-feasible varyingly forceful operations of the operating device can be utilized to give the user as precise as possible a sensation of the squeeze-out process.

The invention is based on the surprising finding that by using a motor and by controlling the motor depending on the force or the torque acting on the operating device, it is possible to also squeeze out highly viscous dental impression compounds by means of the squeeze-out device according to the invention, but at the same time the user has, as a result of the necessary force that has to be applied, a haptic sensation of how easy or how difficult it is to propel the actuator and thus how much resistance is opposed to the dental impression compound squeezed out of the cartridge or the dental material squeezed out of the cartridge. As a result, haptic control of the propulsion of the actuator is possible, and during squeeze-out processes of this kind, the user can utilize this sensory information and their experience. In addition, in this way, experience that has been acquired in the use of low-viscosity dental materials or impression compounds can also be utilized in the use of highly viscous dental impression compounds. Within the scope of the present invention, it was found that it is helpful if the haptic experience of the user can also be made utilizable for driving out tough and highly viscous dental materials or impression compounds.

The idea on which the invention is based is that the mode of application for the application of the smaller cartridges with which the impression compound is applied extraorally or in the mouth is not changed. It is further intended for the known and conventional cartridges and mixers to be able to be used as previously. Such cartridges are available for example from the companies Sulzer, Mixpac and Ritter. It is further particularly preferably intended for the user to be able, in the usual way, to hold in their hand a type of gun into which the cartridge plus mixer is inserted. By operating the cartridge gun, the user is intended to be made able to discharge the dental material or the dental impression compound in a way with which said user is also familiar for lower-viscosity dental impression compounds.

According to the invention, the squeeze-out device acts as support for the operator of the squeeze-out device. Here the driving of the actuator is driven like the brakes of a car having a brake booster or like the torque-dependent activation of an electric motor in some electric bikes. In the same way as electric bikes in which a torque sensor supports the pedaling by means of a motor depending on the used pedaling force of the cyclist, in the squeeze-out device according to the invention the squeeze-out force acting by means of the actuator is supported or provided entirely depending on the force acting on the operating device.

It is novel that in the squeeze-out device or in the ejection gun, a motor and an energy supply plus controller are housed such that in a sensor-controlled manner, the motor supports the user in squeezing out and optionally mixing the dental impression compounds, depending on the force or the torque that the user applies to the gun handle and trigger or the operating device.

The connection to the discharging plungers of the cartridge system can in this case be purely electronic or electromechanical. However, a mechanical connection to the operating device is also possible, the motor in this case intervening for support.

Similar systems are known for example from motor manufacturers IQ, Brose, Bosch, Yamaha, Panasonic and Fazua. For example, the manufacturer “Rocky Mountain” provides a bicycle having a torque sensor that is located on the chain and, by means of an intelligent controller, actuates the motor, which is connected to a classic system. Such systems can theoretically or in principle be transferred to squeeze-out devices according to the invention.

The advantages of squeeze-out devices according to the invention are the smaller squeeze-out forces that are to be manually applied, said squeeze-out forces still providing a sensation of the amount and conveyance speed of the impression compound. In addition, exact metering is possible. Furthermore, there is the possibility of also conveying type 0 “putty” materials and using smaller or spatially more compact mixers. Generally, the squeeze-out device according to the invention requires only a small transition for the user.

In the following, further embodiments of the invention are described on the basis of two schematic figures, without limiting the invention in the process. In the drawings:

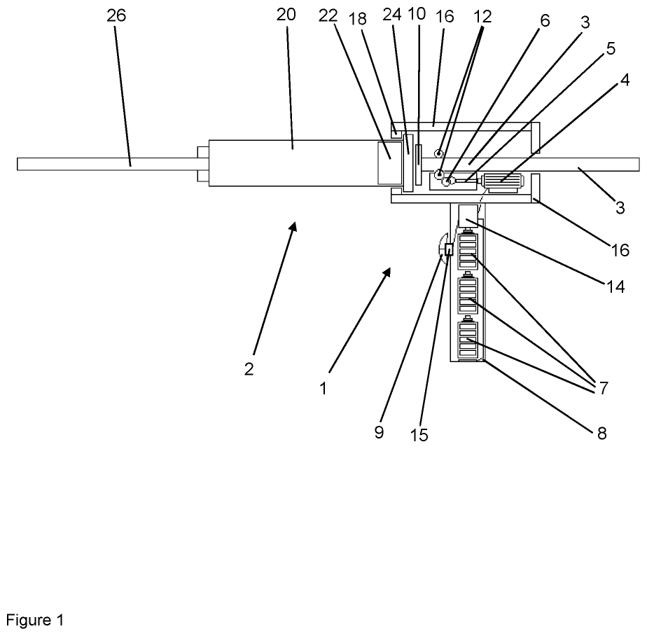

FIG. 1: is a schematic cross-sectional view of a squeeze-out device according to the invention, into which a cartridge system containing the starting components for a dental impression compound has been inserted; and

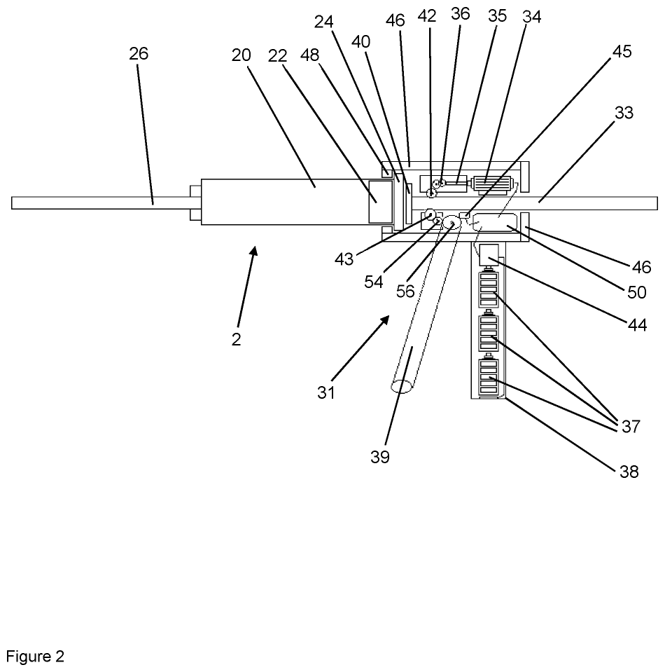

FIG. 2: is a schematic cross-sectional view of an alternative squeeze-out device according to the invention, into which a cartridge system containing the starting components for a dental impression compound has been inserted.

FIG. 1 is a schematic cross-sectional view of a squeeze-out device 1 according to the invention (the right-hand region in FIG. 1), into which a conventional cartridge system 2 (the left-hand region in FIG. 1) can be inserted. The cartridge system 2 can contain starting components of a dental impression compound. The squeeze-out device 1 can have an actuator 3, which can be designed as a push rod. The actuator 3 can also be implemented by two push rods arranged in parallel, in order to be able to thereby squeeze out the contents of two cartridges positioned in parallel. The actuator 3 can be drivable by a motor 4. In a preferred embodiment, the motor 4 can be designed as an electric motor. The motor 4 can be connected to at least one drive element 12 via a coupling 5 and via a gearing 6. In addition, at least one drive shaft can also be provided. The at least one drive element 12 can be connected to the actuator 3 such that the actuator 3 is linearly drivable in an axial direction by the at least one drive element 12. The at least one drive element 12 can be for example at least one toothed gear, wherein the actuator 3 can then preferably have at least one toothed rod or can be designed as at least one toothed rod such that by rotating the at least one toothed gear, the at least one toothed rod and thus the actuator 3 are linearly driven in the axial direction. Other possibilities for propelling the actuator 3 by means of the motor 4 are in principle known and likewise usable. For the energy supply of the motor 4, an energy store 7 in the form of multiple rechargeable batteries or battery cells can be contained in the squeeze-out device 1.

Theoretically a compressed-gas cartridge can also be used as the energy store 7 if a compressed-gas motor is used as the motor 4.

On one side of the squeeze-out device 1, a handle 8 can be arranged, in which the energy store 7 can be arranged. The squeeze-out device 1 can thus be designed in the manner of a cartridge gun. The user can hold the squeeze-out device 1 with one hand on the handle 8. On the handle 8, a button 9 can be arranged as an operating device of the squeeze-out device 1. As a result, the squeeze-out device 1 can be designed to be operable with one hand.

At the tip of the actuator 3 (at the left-hand end of the actuator 3 in FIG. 1), a plate 10 can be provided, wherein with one side of the plate 10, pressure can be exerted on the cartridge system 2 in order to squeeze out and optionally apply the contents of the cartridge system 2.

A controller 14 can be provided in order to control the motor 4. In this case, the power or force delivered by the motor 4 can be controlled or regulated by the controller 14.

A force sensor 15 can be arranged on the handle 8 and connected to the button 9. By means of the force sensor 15, the force with which the button 9 is pressed or operated can be measured. The force sensor 15 can be connected to the controller 14 such that the controller 14 has access to the measurement data, the signal or the measured quantity from the force sensor 15. The controller 14 can be programmed, connected or designed such that the power or the force of the motor 4 is controlled depending on the force measured by the force sensor 15. Preferably the power or the force of the motor 4 can be controlled proportionally or particularly preferably with a linear dependence on the force measured by the force sensor 15. It can be provided that the proportionality or the dependence of the adjustment of the power or the force of the motor 4 on the force measured by the force sensor 15 is adjustable, in particular manually adjustable, by means of an operating element (not shown).

The handle 8 can be connected to a housing 16 of the squeeze-out device 1. In this case, the handle 8 can be part of the housing 16. The housing 16 and the handle 8 can be formed from a plastics material by means of an injection-molding technique. The actuator 3 can protrude out of the housing 16. On one side of the squeeze-out device 1, an attachment element 18 for attaching the cartridge system 2 can be arranged. The attachment element 18 can be connected to the housing 16 or can also be configured in one piece with the housing 16.

The actuator 3 can be movable in the axial direction in relation to the attachment element 18 and the housing 16 such that by moving the actuator 3, a force can be exerted on a cartridge system 2 attached to the attachment element 18.

The cartridge system 2 can have a cartridge 20 or also two cartridges 20 arranged in parallel (both not seen in FIG. 1). In the cartridge 20 of the cartridge system 2, a discharging plunger 22 can be arranged, or in each of the two cartridges 20 of the cartridge system 2, a discharging plunger 22 can be arranged. The discharging plunger(s) 22 can be movable in the longitudinal direction of the cartridge(s) 20 such that contents of the cartridge(s) 20 are drivable out of the cartridge 20 or the cartridges 20. On the rear side of the cartridge system 2 (on the right in FIG. 1), a mating attachment element 24 can be arranged such that the mating attachment element 24 can be attached to the attachment element 18 (for example in the manner of a bayonet closure or in the manner of a screw closure).

On the front side of the cartridge system 2 (on the left in FIG. 1), a discharge tube 26 having an integrated static or also active mixer can be arranged. The contents of the cartridge(s) 20 can be mixed by the mixer when driving out the contents of the cartridge(s) 20. By propelling the discharging plunger 22 or the discharging plungers 22, the contents of the cartridge(s) 20 can be squeezed out through the discharge tube 26. The discharging plunger 22 or the discharging plungers 22 can be driven by the actuator 3 of the squeeze-out device 1 if the cartridge system 2 is connected to the squeeze-out device 1.

A method according to the invention can proceed for example as follows. A cartridge system 2 can be connected or have been connected to the squeeze-out device 1. The button 9 can be pressed by the user. Depending on the intensity of the pressure, i.e. depending on the force exerted on the button 9, the controller 14 can operate the motor 4 at a high or low power or with a large or small force. As a result, the actuator 3 can be propelled with a large force or a small force. The user is thus given a haptic sensation of the force with which the cartridge system 2 is squeezed out.

FIG. 2 is a schematic cross-sectional view of an alternative squeeze-out device 31 according to the invention (the right-hand region in FIG. 2), into which a conventional cartridge system 2 (the left-hand region in FIG. 2), like that according to FIG. 1, can have been or can be inserted. The cartridge system 2 can contain starting components of a dental impression compound. The squeeze-out device 31 can have an actuator 33, which can be designed as a push rod. The actuator 33 can also be implemented by two push rods arranged in parallel, in order to be able to thereby squeeze out the contents of two cartridges positioned in parallel. The actuator 33 can be manually drivable, wherein the manual driving can be intensified or supported by a motor 34. In a preferred embodiment, the motor 34 can be designed as an electric motor. The motor 34 can be connected to at least one drive element 42 via a coupling 35 and via a gearing 36. In addition, at least one drive shaft can also be provided. The at least one drive element 42 can be connected to the actuator 33 such that the actuator 33 is linearly drivable in an axial direction by the at least one drive element 42. The at least one drive element 42 can be for example at least one toothed gear, wherein the actuator 33 can then preferably have at least one toothed rod as a push rod or can be designed as at least one toothed rod such that by rotating the at least one toothed gear, the at least one toothed rod and thus the actuator 33 are linearly driven in the axial direction. Other possibilities for supporting the propulsion of the actuator 33 by means of the motor 34 are in principle known and likewise usable. For the energy supply of the motor 34, an electrical energy store 37 in the form of multiple rechargeable batteries or battery cells can be contained in the squeeze-out device 31.

On one side of the squeeze-out device 31, a handle 38 can be arranged, in which the energy store 37 can be arranged. The squeeze-out device 31 can thus be designed in the manner of a cartridge gun. The user can hold the squeeze-out device 31 with one hand on the handle 38. In the region of the handle 38, a pivotable lever 39 can be arranged as an operating device of the squeeze-out device 31. As a result, the squeeze-out device 31 can be designed to be operable with one hand.

At the tip of the actuator 33 (at the left-hand end of the actuator 33 in FIG. 2), at least one plate 40 can be provided, wherein with one side of the at least one plate 40, pressure can be exerted on the cartridge system 2 in order to squeeze out and optionally apply the contents of the cartridge system 2.

The lever 39 can be connected to the actuator 33 via a drive element 43. Between the drive element 43 and the lever 39, another gearing 54 can be arranged, by means of which the force applied by the lever 39 or the torque applied by the lever 39 can be changed, in particular can be increased, when being transmitted to the drive element 43 and thus to the actuator 33. By operating the lever 39, in which the lever 39 is pivoted or rotated about a pivot pin 56, the actuator 33 can be manually driven via the drive element 43. As a result, from the required force or from the required torque therefor, the user can draw conclusions about the resistance and thus about the use situation. For very tough and highly viscous dental impression compounds, the manually appliable force is often insufficient. If the squeeze-out device 31 were designed differently and translation by the gearing 54 were selected such that a stroke of the lever 39 squeezed out only an extremely small amount of the dental impression compound, a very large number of stroke movements of the lever 39 would be necessary. Since each stroke movement leads to a movement of the application tip, such a squeeze-out device 31 would be difficult to use precisely, and imprecise application of the impression compound or the material could arise. In addition, the squeeze-out process would take a great deal of time as a result of the large number of necessary stroke movements. Therefore, according to the invention, support for the driving of the actuator 33 by the motor 34 can be provided.

A transformer 44 can transform the electrical voltage provided by the energy store 37 to an electrical voltage suitable for the motor 34. A controller 50 can be provided in order to control the motor 34. In this case, the power or force delivered by the motor 34 can be controlled or regulated by the controller 50.

A force sensor 45 can be arranged in the squeeze-out device 31 and can be connected to the lever 39. By means of the force sensor 45, the force with which the lever 39 is pressed and/or the torque with which the lever 39 is pressed or operated can be measured. The force sensor 45 can be connected to the controller 50 such that the controller 50 has access to the measurement data, the signal or the measured quantity or quantities from the force sensor 45. The controller 50 can be programmed, connected or designed such that the power or the force of the motor 34 is controlled depending on the force measured by the force sensor 45 and/or the measured torque. Preferably the power or the force of the motor 34 can be controlled proportionally or particularly preferably with a linear dependence on the force measured by the force sensor 45 and/or on the torque measured by the force sensor 45. It can be provided that the proportionality or the dependence of the adjustment of the power or the force of the motor 34 on the force measured by the force sensor 45 or the torque measured by the force sensor 45 is adjustable, in particular manually adjustable, by means of an operating element (not shown).

The handle 38 can be connected to a housing 46 of the squeeze-out device 31. In this case, the handle 38 can be part of the housing 46. The housing 46, the handle 38 and the lever 39 can be formed from a plastics material by means of an injection-molding technique. The actuator 33 can protrude out of the housing 46. On one side of the squeeze-out device 31, an attachment element 48 for attaching the cartridge system 2 can be arranged. The attachment element 48 can be connected to the housing 46 or can also be configured in one piece with the housing 46.

The actuator 33 can be movable in the axial direction in relation to the attachment element 48 and the housing 46 such that by moving the actuator 33, a force can be exerted on a cartridge system 2 attached to the attachment element 48.

The cartridge system 2 can have a cartridge 20 or also two cartridges 20 arranged in parallel (both not seen in FIG. 2). In the cartridge 20 of the cartridge system 2, a discharging plunger 22 can be arranged, or in each of the two cartridges 20 of the cartridge system 2, a discharging plunger 22 can be arranged. The discharging plunger(s) 22 can be movable in the longitudinal direction of the cartridge(s) 20 such that contents of the cartridge(s) 20 are drivable out of the cartridge 20 or the cartridges 20. On the rear side of the cartridge system 2 (on the right in FIG. 2), a mating attachment element 24 can be arranged such that the mating attachment element 24 can be attached to the attachment element 48 (for example in the manner of a bayonet closure or in the manner of a screw closure).

On the front side of the cartridge system 2 (on the left in FIG. 2), a discharge tube 26 having an integrated static or also dynamic (active) mixer can be arranged. The contents of the cartridge(s) 20 can be mixed by the mixer when driving out the contents of the cartridge(s) 20. By propelling the discharging plunger 22 or the discharging plungers 22, the contents of the cartridge(s) 20 can be squeezed out through the discharge tube 26. The discharging plunger 22 or the discharging plungers 22 can be driven by the actuator 33 of the squeeze-out device 31 if the cartridge system 2 is connected to the squeeze-out device 31.

A method according to the invention can proceed for example as follows. A cartridge system 2 can be connected or have been connected to the squeeze-out device 31. The lever 39 can be operated by the user. The force applied to the lever 39 or the torque applied to the lever 39 can be transmitted to the actuator 33 via the gearing 54 and the drive element 43. In addition, the actuator 33 can also be driven by the motor 34, and thus the movement of the actuator 33 can be supported in a motor-driven manner. Depending on the intensity of the pivoting of the lever 39, i.e. depending on the force exerted on the lever 39, the controller 50 can operate the motor 34 at a high or low power or with a large or small force. The measurement for this purpose can take place by means of the force sensor 45. As a result, the actuator 33 can be propelled with a large degree of force support or a small degree of force support from the motor 34. The user is thus given a haptic sensation of the force with which the cartridge system 2 is squeezed out.

The features of the invention disclosed in the above description and the Claims, drawings and embodiments can be essential to the implementation of the invention in the various embodiments thereof, both individually and in any desired combination.

### LIST OF REFERENCE NUMERALS

1, 31 squeeze-out device
2 cartridge system
3, 33 actuator
4, 34 motor
5, 35 coupling
6, 36 gearing
7, 37 energy store
8, 38 handle
9 button
10, 40 plate
12, 42 drive element
14 controller
15, 45 force sensor
16, 46 housing
18, 48 attachment element
20 cartridge
22 discharging plunger
24 mating attachment element
26 discharge pipe with mixer
39 lever
43 drive element
44 transformer
50 controller
54 gearing
56 pivot pin

1. A squeeze-out device for driving out a highly viscous dental material from a cartridge system, the squeeze-out device having an actuator, a motor, a controller, an operating device, and at least one force sensor (15, 45), wherein at least one discharging plunger of the cartridge system is drivable by the actuator, wherein the actuator is drivable by the motor or mechanically transmitted driving of the actuator is supportable by the motor, wherein the operating device is manually operable, wherein the at least one force sensor is connected to the operating device such that at least a magnitude of a force acting on the operating device and/or at least a magnitude of a torque acting on the operating device is measurable, and wherein the motor is controllable by the controller depending on the measured magnitude of the force acting on the operating device and/or of the torque acting on the operating device, said magnitude being measured by the at least one force sensor.

2. The squeeze-out device according to claim 1, wherein the squeeze-out device is a cartridge gun.

3. The squeeze-out device according to claim 1, wherein the operating device is a trigger, a lever, or a button.

4. The squeeze-out device according to claim 1, wherein the squeeze-out device has an energy store, energy for driving the motor being extractable from the energy store.

5. The squeeze-out device according to claim 1, wherein the at least one force sensor is suitable or provided for measuring the magnitude of at least one linear force and/or of at least one torque.

6. The squeeze-out device according to claim 1, wherein the controller controls the motor such that a force acting on the actuator from the motor or a torque acting on the actuator from the motor is, in a force range or a torque range, proportional to the magnitude of the force acting on the operating device or of the torque acting on the operating device, said magnitude having been measured by the force sensor).

7. The squeeze-out device according to claim 6, wherein the proportionality is adjustable.

8. The squeeze-out device according to claim 1, wherein in addition to the magnitude of the force acting on the operating device and/or of the torque acting on the operating device, a direction of the force and/or the torque is also measurable by the force sensor.

9. The squeeze-out device according to claim 1, wherein at least one plate is attached to a front side of the actuator, the at least one discharging plunger of the cartridge system being operable by said plate.

10. The squeeze-out device according to claim 1, wherein a dependency of a power or force of the motor acting on the actuator on the magnitude of the force acting on the operating device and/or of the torque acting on the operating device, said magnitude having been measured by the force sensor, is adjustable.

11. The squeeze-out device according to claim 1, wherein the operating device is connected to the actuator such that a force acting on the operating device and/or a torque acting on the operating device is transmittable to the actuator for driving the at least one discharging plunger of the cartridge system.

12. The squeeze-out device according to claim 1, wherein the squeeze-out device is suitable for squeezing out cartridge systems for dental impression compounds and for this purpose has an attachment element, which is attachable to the cartridge system.

13. The squeeze-out device according to claim 1, wherein the squeeze-out device is suitable for squeezing out cartridge systems for dental impression compounds of type 1 or type 0 according to DIN ISO 4823:2015.

14. A method for driving at least one discharging plunger of a cartridge system by a squeeze-out device, the method comprising the steps of
operating an operating device by a force acting on the operating device,
measuring, by at least one force sensor, a magnitude of a force acting on the operating device and/or of a torque acting on the operating device, and
driving an actuator by a motor, wherein the actuator) is provided for propelling at least one discharging plunger of a cartridge system, and wherein the motor is controlled depending on[the magnitude of the measured force and/or of the measured torque.

15. The method according to claim 14, comprising carrying out the method by a squeeze-out device having the actuator, the motor, a controller, the operating device, and at least one force sensor, wherein at least the discharging plunger of the cartridge system is drivable by the actuator, wherein the actuator is drivable by the motor or mechanically transmitted driving of the actuator is supportable by the motor, wherein the operating device is manually operable, wherein the at least one force sensor is connected to the operating device such that at least the magnitude of a force acting on the operating device and/or at least the magnitude of a torque acting on the operating device is measurable, and wherein the motor is controllable by the controller depending on the measured magnitude of the force acting on the operating device and/or of the torque acting on the operating device, said magnitude being measured by the at least one force sensor.

16. The method according to claim 14, wherein the actuator is additionally driven mechanically by the operating device.

17. The method according to claim 14, wherein the force acting on the actuator from the motor or the torque acting on the actuator from the motor is, in a range, adjusted proportionally to the magnitude of the force acting on the operating device, said magnitude being measured by the force sensor.

18. The squeeze-out device according to claim 1, wherein the highly viscous dental material is a dental impression compound.

19. The squeeze-out device according to claim 3], wherein the squeeze-out device is operable by the trigger, the lever, or the button using a same hand with which the squeeze-out device is holdable single handedly.

20. The squeeze-out device according to claim 4, wherein the energy store is selected from the group consisting of a battery store, a rechargeable battery, or a compressed-gas reservoir.

21. The squeeze-out device according to claim 7, wherein the proportionality is manually adjustable by an operating element.

22. The squeeze-out device according to claim 8, wherein the direction of the force and/or of the torque is usable to control the motor by the controller.

23. The squeeze-out device according to claim 11, wherein the force and/or the torque are mechanically transmittable.

24. The squeeze-out device according to claim 23, wherein the force and/or the torque are transmittable by a lever and/or a gearing.

25. The squeeze-out device according to claim 12, wherein the squeeze-out device is suitable for squeezing out two-component cartridges for dental impression compounds.

26. The squeeze-out device according to claim 12, wherein the cartridge system provides a volume of between 5 ml and 100 ml of the dental impression compound, or a volume of between 25 ml and 100 ml of the dental impression compound, or a volume of 50 ml of the dental impression compound.

27. The method according to claim 17, wherein a proportionality constant is adjusted.
